(19) United States
(12) Patent Application Publication
(10) Pub. No.: US 2007/0102098 A1
(43) Pub. Date: May 10, 2007

(54) Method for making shell for electric product

(76) Inventor: Swei Mu Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/272,326

(22) Filed: Nov. 9, 2005

(51) Int. Cl. B32B 37/00; B29C 47/00

(52) U.S. Cl. 156/154; 156/245; 156/267

(57) ABSTRACT

A method is used for manufacturing outer housings or shells for electric products or mobile communication devices and includes a base layer having an outer pattern and an inner peripheral portion, a cushioning layer is attached into the inner peripheral portion of the base layer to form a housing member of a shell, and burrs are removed from the housing member to form a smooth outer peripheral surface. An anti-static electricity material and/or natural fibers and/or wood chips and/or recycled cut off materials or waste plastic materials or particles and/or electric conductive materials may be engaged into the cushioning layer. A transparent cover layer may be applied onto the base layer.

### BACKGROUND OF THE INVENTION

1. Field of the Invention

The present invention relates to a shell manufacturing method, and more particularly to a method for making or manufacturing outer housings or shells for cushioning and protecting electric products.

2. Description of the Prior Art

Typical electrical products or devices, such as portable or mobile phones, personal digital assistants, electric game cards, electric mice, monitors, electric digital panels, portable computers, personal computers, or the like comprise an outer housing or shell which is normally made of plastic materials and formed by such as molding or mold-injection processes, and for allowing the outer housings or shells to be manufactured in great speed and in mass production.

For example, U.S. Pat. No. 6,341,227 to Möoster et al. discloses one of the typical methods for manufacturing mobile communication devices, and also comprising one or more housing members that are normally manufactured or made of plastic materials and formed by such as molding or mold-injection processes.

U.S. Patent Application Publication No. US 2002/0085709 A1 to Hsu discloses another typical cover for mobile or portable phones, and also comprising one or more housing members that are normally manufactured or made of plastic materials and formed by such as molding or mold-injection processes, and comprising a number of catches for securing the housing members together.

However, the outer housings or shells are normally made of plastic materials which may not be used to suitably absorb or dissipate shocks and vibrations; i.e., the electric parts or elements received within the outer housings or shells may not be suitably cushioned or protected by the outer housings or shells.

The present invention has arisen to mitigate and/or obviate the afore-described disadvantages of the conventional methods for manufacturing outer housings or shells for electric products or mobile communication devices.

### SUMMARY OF THE INVENTION

The primary objective of the present invention is to provide a method for making or manufacturing outer housings or shells which may be provided or used for cushioning and protecting the electric products or mobile communication devices.

The other objective of the present invention is to provide a method for making or manufacturing outer housings or shells which may further include natural fibers or wood chips or recycled cut off materials or waste plastic materials or particles engaged or embedded into the cushioning layer for economizing purposes, and for reducing pollution problems.

The further objective of the present invention is to provide a method for making or manufacturing outer housings or shells which may further include anti-static electricity material or electric conductive materials engaged or embedded into the cushioning layer.

In accordance with one aspect of the invention, there is provided a method for manufacturing outer housings or shells for electric products or mobile communication devices, the method comprising providing a base layer having a pattern provided thereon and having an inner peripheral portion formed therein, attaching a cushioning layer in the inner peripheral portion of the base layer to form a housing member of a shell, and removing burrs from the housing member to form a smooth outer peripheral surface or outer contour.

An anti-static electricity material and/or natural fibers and/or wood chips and/or recycled cut off materials or waste plastic materials or particles and/or electric conductive materials may further be provided and engaged or embedded into the cushioning layer.

A cover layer may further be provided and applied onto the base layer, the cover layer is preferably made of transparent or semi-transparent materials for allowing the pattern on the base layer to be seen.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a portable or mobile phone to be manufactured with a method in accordance with the present invention, in which a portion of the portable or mobile phone has been cut off for showing an inner structure of the portable or mobile phone;

FIG. 2 is an enlarged partial perspective view of the portable or mobile phone;

FIG. 3 is a perspective view illustrating a housing member of the portable or mobile phone;

FIG. 4 is a cross sectional view illustrating the molding process for manufacturing the portable or mobile phone;

FIG. 5 is an enlarged partial cross sectional view illustrating the mold device;

FIG. 6 is a partial exploded view illustrating the materials for forming the housing member of the portable or mobile phone;

FIG. 7 is a cross sectional view similar to FIG. 4, illustrating the other molding process for manufacturing the portable or mobile phone;

FIG. 8 is a cross sectional view similar to FIG. 8, illustrating the other molding process for manufacturing the portable or mobile phone;

FIG. 9 is a plan view illustrating an outer housing or shell for the other electric products;

FIG. 10 is a perspective view illustrating a personal digital assistant or an electric digital panel to be made with the outer housing or shell manufactured with a method in accordance with the present invention, in which a portion of the personal digital assistant or electric digital panel has been cut off for showing an inner structure thereof; and

FIGS. 11, 12, 13 are perspective views similar to FIG. 10, illustrating an electric game card, an electric mouse, and a monitor or portable computer to be made with the outer housing or shell manufactured with a method in accordance with the present invention, in which a portion of the electric game card or the electric mouse or the monitor or the portable computer has been cut off for showing an inner structure thereof.

### DETAILED DESCRIPTION OF THE PREFERRED EMBODIMENT

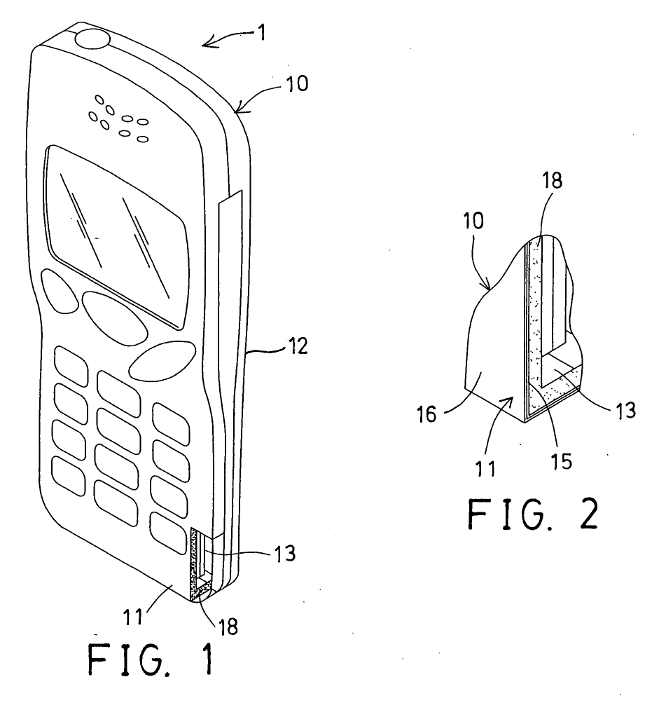

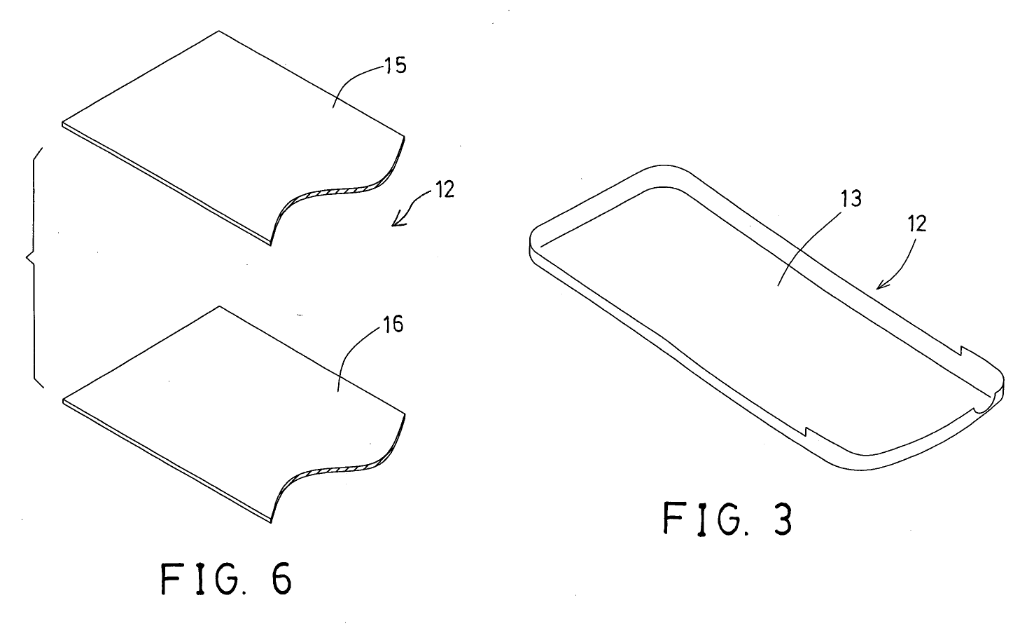

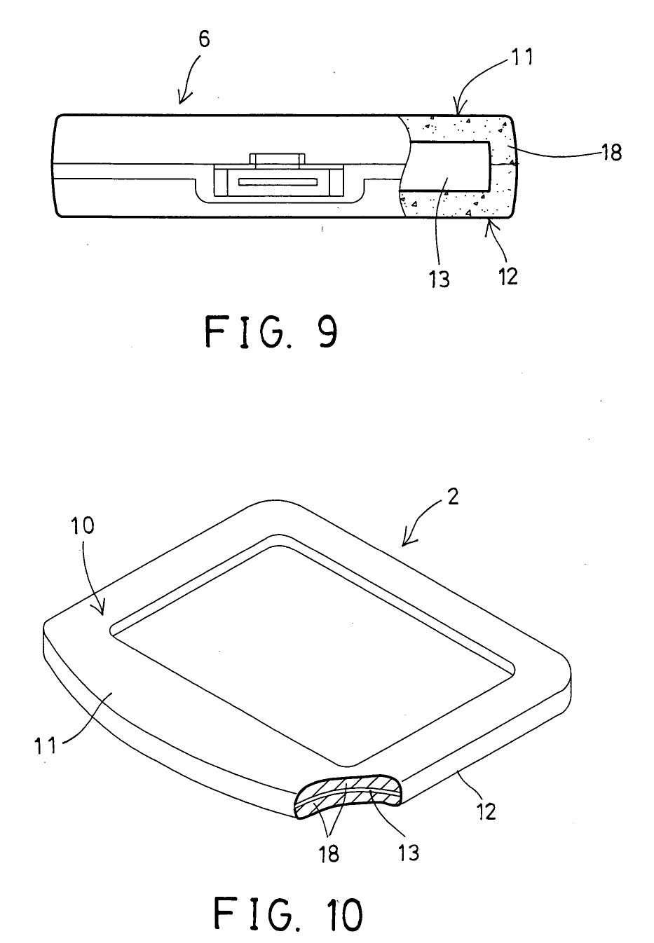

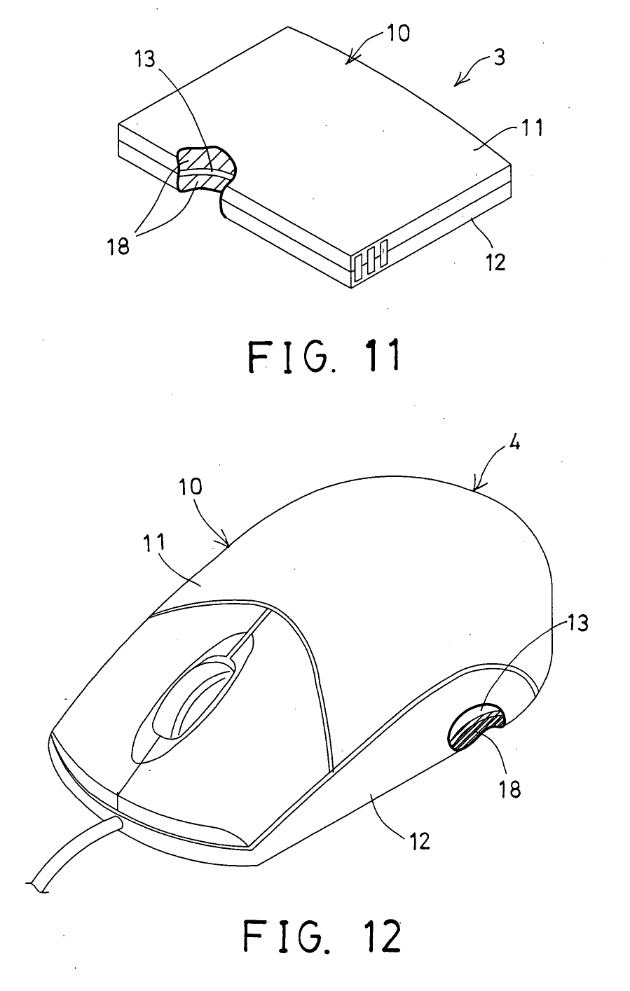

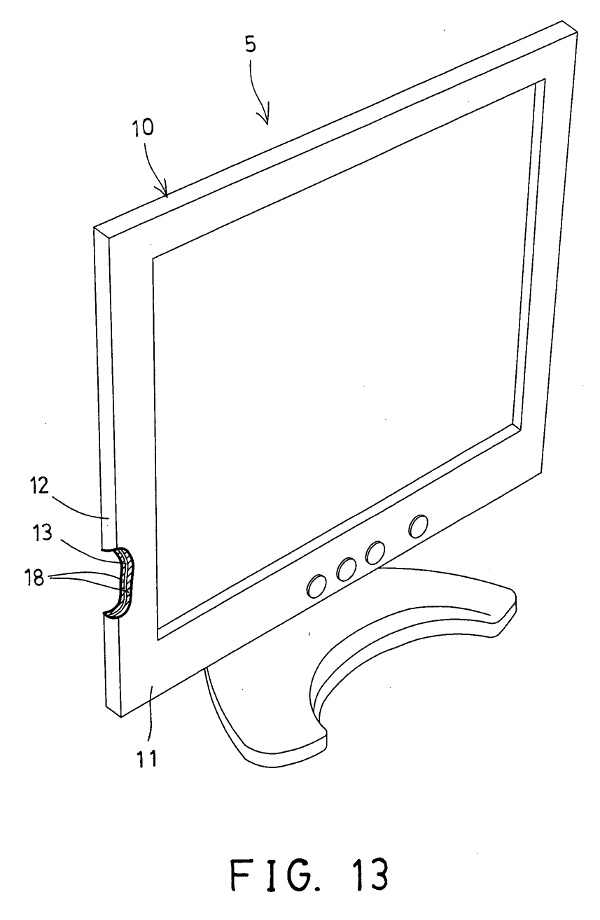

Referring to the drawings, and initially to FIGS. 1 and 2, a method in accordance with the present invention is provided for manufacturing an outer housing or shell 10 for various electric products 1, such as the portable or mobile phone 1 as shown in FIG. 1, the personal digital assistant or electric digital panel 2 as shown in FIG. 10, the electric game card 3 as shown in FIG. 11, the electric mouse 4 as shown in FIG. 12, the monitor or portable computer 5 as shown in FIG. 13, or the other electric products 6 as shown in FIG. 9.

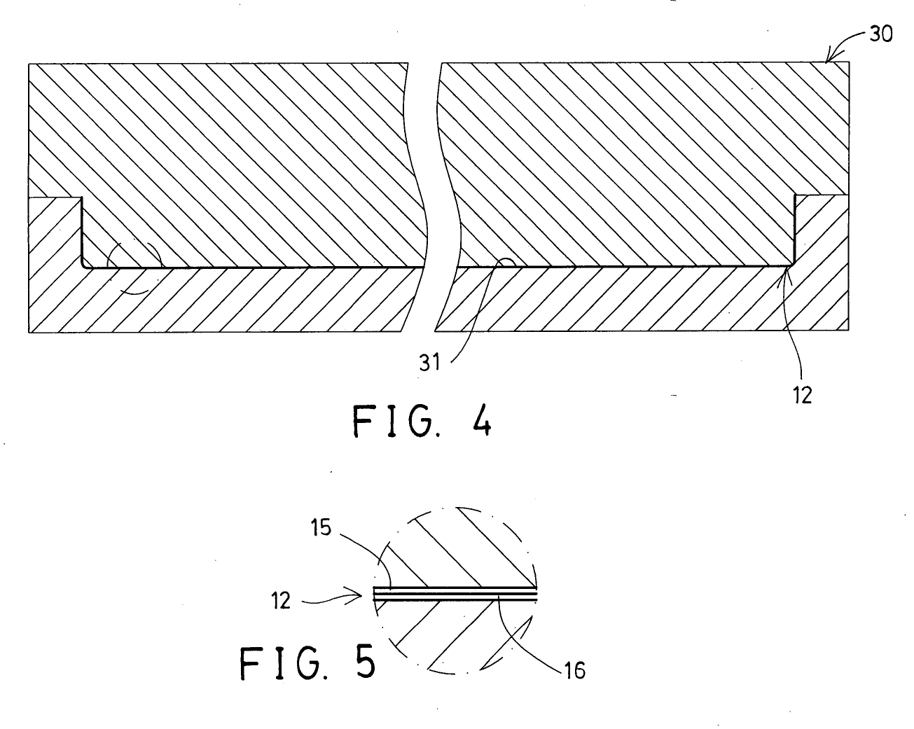

The shell 10 may comprise one or more housing members 11, 12 to be secured together with such as fasteners or latches (not shown), adhesive materials, or by welding processes, and each having a chamber 13 formed therein (FIGS. 1-3 and 9-13) for receiving various electric parts or elements therein (not shown). The housing members 11, 12 of the shell 10 each includes an inner or base layer 15 (FIGS. 4-6) preferably made of plastic or synthetic materials and formed by such as molding or mold-injection processes with a mold device 30 as shown in FIG. 4, and each may include various colors or decorative patterns formed on the outer peripheral portion thereof.

The housing members 11, 12 of the shell 10 each may further include an anti-corrosive and/or anti-abrasive outer or cover layer 16 applied or attached onto the outer peripheral portion of the inner or base layer 15, best shown in FIGS. 5 and 6, and made of transparent or semi-transparent materials for allowing the colors or decorative patterns formed on the outer peripheral portion of the inner or base layer 15 to be seen by the users or by people. The outer or cover layer 16 may be attached or secured onto the inner or base layer 15 by the heat in such as the hot-pressing process or the molding or mold-injection processes.

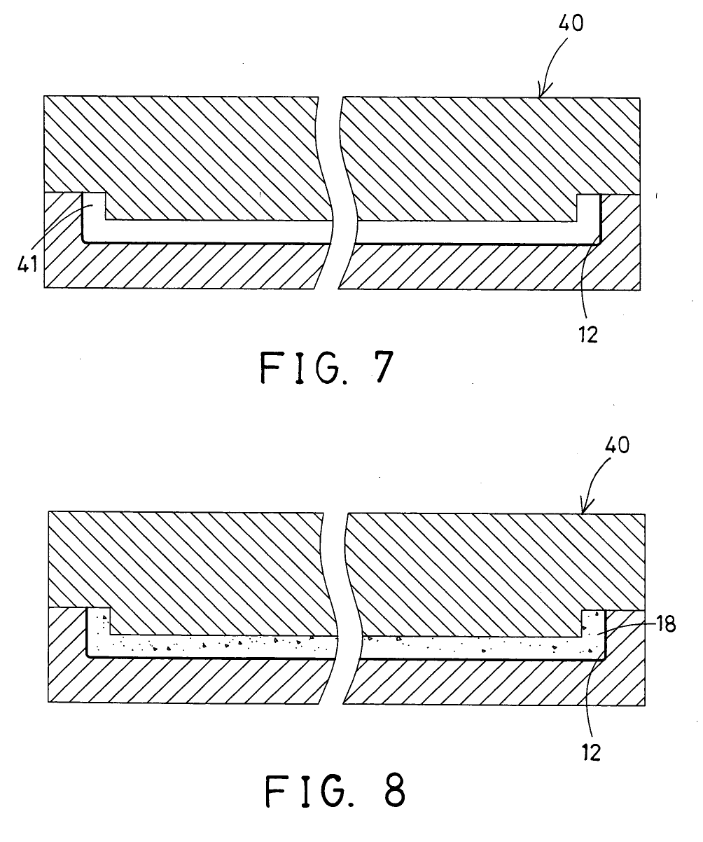

The inner or base layer 15 may be anchored or positioned or retained within the mold device 30 with such as a vacuuming process, for forming a space within the mold device 30 and for allowing the material to be filled or introduced or injected into the mold cavity 31 of the mold device 30, in order to form the outer or cover layer 16 on the inner or base layer 15. The housing members 11, 12 of the shell 10 may then be further engaged into another mold device 40 as shown in FIGS. 7 and 8 which includes a mold cavity 41 formed therein (FIG. 7).

A foamable material or cushioning material or synthetic material may then be filled or introduced or injected into the mold cavity 41 of the mold device 40, in order to form a cushioning layer 18 in the inner peripheral portion of either or both of the housing members 11, 12 of the shell 10. The foamable material or cushioning material or synthetic material may include a suitable softness or resilience or the like for absorbing or dissipating the shocks and vibrations that may be applied to the housing members 11, 12 of the shell 10, and thus for suitably cushioning or protecting the electric parts or elements (not shown) received within the outer shell 10.

The foamable material or cushioning material or synthetic material may also attached or secured onto the housing members 11, 12 by the heat in such as the hot-pressing process or the molding or mold-injection processes. A trimming or finishing process may further be required or may be selectively provided to remove the burrs that may be formed on the outer peripheral portion of thus formed or molded housing members 11, 12 of the shell 10, for forming a smooth and/or shiny outer peripheral surface or contour for the housing members 11, 12 of the shell 10. Each of the electric products 1-6 may include two or more shells 10 having different colors or decorative patterns formed on the outer peripheral portion thereof for allowing the shells 10 to be changed from each other.

It is to be noted that an additional leather or cloth layer may further be provided and attached or secured onto either the inner portion or the outer portion of the housing members 11, 12 of the shell 10 during the molding processes for forming a different outer peripheral surface. Wood chips or natural fibers or other recycled cut off materials or waste plastic materials or particles, and/or anti-static electricity or electric conductive materials may further be provided and engaged or embedded into the foamable material or cushioning material or synthetic material for forming the cushioning layer 18 of the housing members 11, 12 of the shell 10.

In operation, as shown in FIGS. 1 and 9-13, the method in accordance with the present invention may be provided for making or manufacturing the housing members 11, 12 of the shell 10 of various electric products 1, such as the portable or mobile phone 1 (FIG. 1), the personal digital assistant or electric digital panel 2 (FIG. 10), the electric game card 3 (FIG. 11), the electric mouse 4 (FIG. 12), the monitor or portable computer 5 (FIG. 13), or the other electric products 6 (FIG. 9), for cushioning and protecting various electric parts or elements (not shown) received therein.

Accordingly, the method in accordance with the present invention may be provided for making or manufacturing outer housings or shells which may be provided or used for cushioning and protecting the electric products or mobile communication devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for manufacturing outer housings or shells for electric products or mobile communication devices, said method comprising:
providing a base layer having a pattern provided thereon and having an inner peripheral portion formed therein,
attaching a cushioning layer in said inner peripheral portion of said base layer to form a housing member of a shell, and
removing burrs from said housing member to form a smooth outer peripheral surface.

2. The method as claimed in claim 1 further comprising introducing anti-static electricity material into said cushioning layer.

3. The method as claimed in claim 1 further comprising introducing natural fibers into said cushioning layer.

4. The method as claimed in claim 1 further comprising introducing electric conductive material into said cushioning layer.

5. The method as claimed in claim 1 further comprising applying a cover layer onto said base layer, said cover layer being made of transparent materials for allowing the pattern on said base layer to be seen.
